(19) United States
(12) Patent Application Publication
(10) Pub. No.: US 2020/0208664 A1
(43) Pub. Date: Jul. 2, 2020

(54) CONNECTING MECHANISM

(71) Applicant: Tymphany Acoustic Technology (Huizhou) Co., Ltd., Huizhou City (CN)

(72) Inventor: Tianbao XIE, Huizhou City (CN)

(21) Appl. No.: 16/666,937

(22) Filed: Oct. 29, 2019

(30) Foreign Application Priority Data
Dec. 27, 2018 (CN) 201822219960.3

(51) Int. Cl. F16B 5/12

(52) U.S. Cl. CPC F16B 5/126

(57) ABSTRACT

A connecting mechanism, configured to connect a plurality of plates, includes a main body, having a first surface and a second surface, and being of an elongate strip-shaped structure; a first groove, provided on the first surface; a plurality of locating columns, disposed on two sides of the first groove; and a second groove, provided at a position of the second surface corresponding to the first groove. When the connecting mechanism is connected to the plurality of plates, the plurality of locating columns are inserted into the locating holes of the plates which have the positions and shapes corresponding to the locating columns, the plates are connected to the two sides of the connecting mechanism and foldable towards a direction of the first groove via the connecting mechanism.

### CROSS REFERENCE TO RELATED APPLICATIONS

This application claims priority to CN 201822219960.3, which was filed on Dec. 27, 2018, and which is herein incorporated by reference.

### TECHNICAL FIELD

The present invention relates to a structure for a connecting mechanism and in particular to a connecting mechanism having a plurality of locating columns.

### BACKGROUND

At present, on a mechanism design of an electronic product, a housing plate is folded or adjusted often by using a traditional connecting mechanism. A plastic column of the traditional connecting mechanism is combined with the plate in a hot melting manner. However, such a hot melting manner cannot stably lock the plate due to a fragile structure.

In addition, for the sake of an aesthetic demand, a decorative surface layer is often provided on an outer surface of the plate. As the plate and the traditional connecting mechanism are folded repeatedly, the decorative surface layer easily has a surface protrusion phenomenon at a folded place.

Therefore, in the design field of the connecting mechanism, much effort has been made to design a connecting mechanism capable of stably connecting the plate and enabling an outer surface layer to be attached stably, to improve the functionality and aesthetic degree of the product.

### SUMMARY OF THE INVENTION

In view of this, the certain exemplary embodiments of present invention provide a connecting mechanism.

The connecting mechanism includes a main body, having a first surface and a second surface, and being of a long strip-shaped structure; a first groove, provided on the first surface; a plurality of locating columns, disposed on two sides of the first groove; and a second groove, provided at a position of the second surface corresponding to the first groove, wherein when the connecting mechanism is connected to the plurality of plates, the plurality of locating columns are inserted into the locating holes of the plates which have the positions and shapes corresponding to the locating columns, the plates are connected to the two sides of the connecting mechanism and foldable towards a direction of the first groove via the connecting mechanism.

In an embodiment, the connecting mechanism is made of a flexible rubber material.

In an embodiment, the first groove is an arc-shaped groove.

In an embodiment, the first groove is a trapezoidal groove.

In an embodiment, each locating column includes a supporting portion and a clamping portion; and a radius of the clamping portion is greater than a radius of the supporting portion.

In an embodiment, the locating columns are disposed on the first surface in a Z-shaped manner.

In an embodiment, the connecting mechanism is formed in the locating holes in an injection molding manner to connect and clamp to the plates.

In conclusion, the connecting mechanism according to the certain exemplary embodiments of the present invention can provide a stable locking function and an attached decorative outer layer for a product, thus improving the functionality and aesthetic degree of the product.

### BRIEF DESCRIPTION OF THE DRAWINGS

FIG. 1 is a stereoscopic schematic diagram of an embodiment of a connecting mechanism according to certain exemplary embodiments of the present invention.

FIG. 2 is a side view of an embodiment of a connecting mechanism according to certain exemplary embodiments of the present invention.

FIG. 3 is an assembly schematic diagram of an embodiment of a connecting mechanism according to certain exemplary embodiments of the present invention.

### DETAILED DESCRIPTION OF THE EMBODIMENTS

In order to understand the present invention conveniently, the present invention will be described more thoroughly in conjunction with the accompanying drawings and specific embodiments. Preferred implementation manners of the present invention are given in the accompanying drawings. However, the present invention may be implemented in many different forms and is not limited to the implementation manners described herein. Reversely, the purpose of providing these implementation manners is to understand the contents of the present invention more thoroughly and comprehensively.

It is to be noted that when an element is referred to as being “fixed on” another element, it may be directly on the other element or an intervening element may also be present. When one element is considered as being “connected to” the other element, it may be directly connected to the other element or an intervening element may also be present.

For the ease of reading, the “upper”, “lower”, “left” and “right” indicated according to the accompanying drawings are merely for indicating a relative reference position of each element and are not intended to limit the present invention.

Unless otherwise defined, all technical and scientific terms used herein have the same meaning as commonly understood by a person skilled in the art to which the present invention belongs. Terms used herein in the specification of the present invention are merely for describing the specific implementation manners but are not intended to limit the present invention.

### Embodiment 1

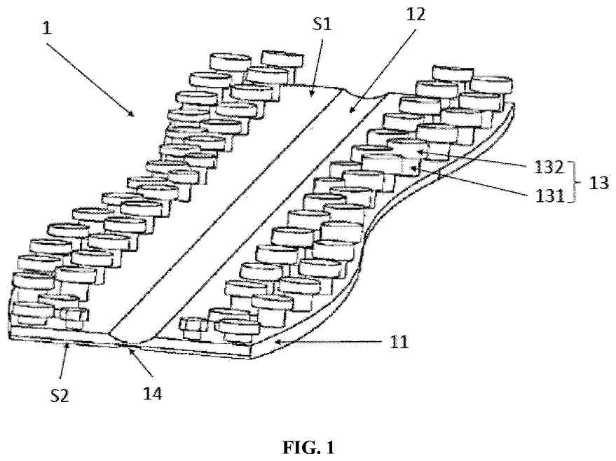

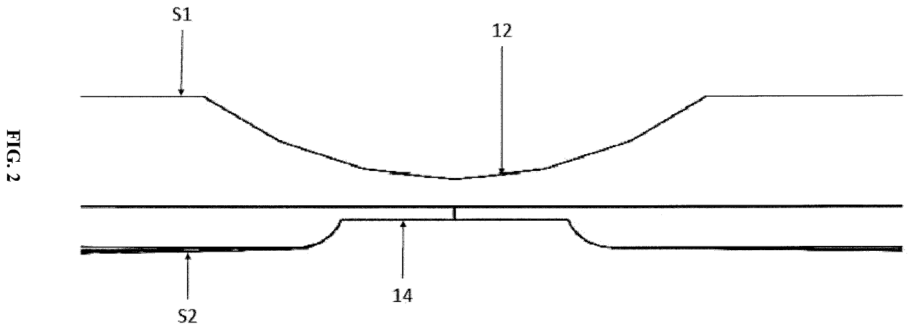

Referring to FIG. 1 and FIG. 2, FIG. 1 is a stereoscopic schematic diagram of an embodiment of a connecting mechanism 1 according to the certain exemplary embodiments of the present invention, and FIG. 2 is a side view of an embodiment of a connecting mechanism 1 according to the certain exemplary embodiments of the present invention. The connecting mechanism 1 includes a body 11, a first groove 12, a plurality of locating columns 13 and a second groove 14. The connecting mechanism 1 is configured to connect a plurality of plates 2 to serve as a housing of a product. Beside the capability of providing a connecting function between the plurality of plates 2, the connecting mechanism 1 provided by the present invention can further provide a folding function, so that the connected plates 2 can be adjusted to a needed connecting angle as required by a designer or a user.

The shape of the body 11 can be adjusted according to the plates to be connected. The body 11 is illustrated as a long strip shape, for example, in this embodiment of the present invention, and is not limited thereto. The shape of the body 11 in actual implementation can be adjusted as required by the designer. In addition, the body 11 is made of a flexible material, where the flexible material may be, but not limited to, a flexible rubber material to provide a bending property for the folding function. The body 11 is further provided with a first surface S1 and a second surface S2. The first surface S1 and the second surface S2 are two opposite planes.

The first groove 12 is provided in a non-edge area of the first surface S1 (that is, two sides of the first groove 12 still have the plane of the first surface S1) rather than an edge area of the first surface S1, wherein the connecting mechanism 1 is foldable towards a direction of the first groove 12 by virtue of a sunken portion of the first groove 12. Additionally, the sunken shape of the first groove 12 can be changed freely as required by the designer. In this embodiment of the utility model, the first groove 12 is illustrated as an arc shape for example and is not limited thereto.

Each locating column 13 is of a cylindrical structure disposed on the first surface S1, and is configured to clamp and connect to a locating hole of each plate 2. In this embodiment, the locating columns 13 are disposed on two sides of the first groove 12 of the first surface S1, that is, in the edge area of the first surface S1. However, the actual setting positions of the locating columns 13 may be changed freely as required by the designer. In this embodiment, the locating columns 13 are disposed on the first surface S1 in a Z-shaped manner to strengthen a clamping force with each plate 2 to be connected. Furthermore, in some embodiments, each locating column 13 may further include a supporting portion 131 and a clamping portion 132, where the supporting portion 131 is of a cylindrical structure connected to the first surface S1, the clamping portion 132 is of a cylindrical structure connected to the supporting portion 131, and a radius of a cylinder of the clamping portion 132 is greater than a radius of a cylinder of the supporting portion 131. In this embodiment, the shapes of locating holes 21 of the plates 2 to be connected are corresponding to the supporting portions 131 and the clamping portions 132.

The second groove 14 is provided in a non-edge area of the second surface S2 (that is, two sides of the second groove 14 still have a plane of the second surface S2) rather than an edge area of the second surface S2. The shape of the second groove 14 may be changed freely as required by the user, for example, a trapezoid or a rectangle. In this embodiment, the shape of the second groove 14 replaces two edges of the trapezoid with a curve. In addition, the position of second groove 14 is corresponding to the position of first groove 12, so that when the connecting mechanism 1 is folded towards the direction of the first groove 12, the second groove 14 is located at the outer surface of the bending part.

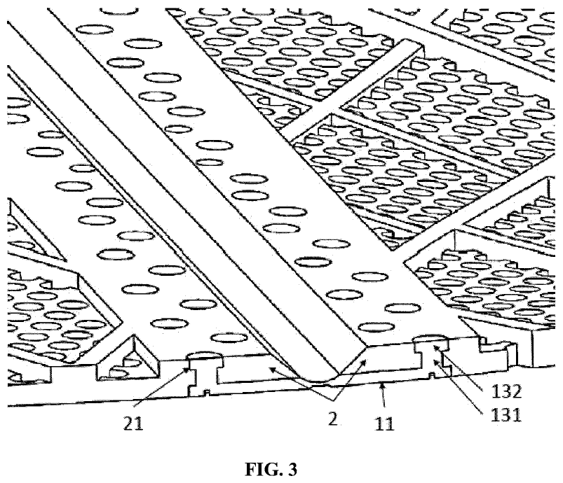

Referring to FIG. 3, FIG. 3 illustrates an assembly schematic diagram of an embodiment of a connecting mechanism 1 according to the present invention. The connecting mechanism 1 is clamped to the locating holes 21 of the plates 2 via the locating columns 13, wherein the clamping manner may be achieved via assembly, or achieved by directly injecting a flexible rubber into the locating holes 21 in an injection molding manner so that the locating columns 13 are molded in the locating holes. After the connecting mechanism 1 is combined with the plates 2, the first surface Si and the second surface S2 of the connecting mechanism 1 further extend to the plates 2, and the user may attach a decorative outer layer to the second surface S2. When the plates 2 are folded towards the direction of the first groove 12, the connecting mechanism 1 may provide a good folding function because the body 11 is made of the flexible rubber material and the first groove 12 provides a bending space.

Moreover, as the decorative outer layer is attached on the second surface S2, and the second groove 14 provides a telescopic space, when the plates 2 are folded towards the direction of the first groove 12, the decorative outer layer still can be stably attached to the second surface S2 after multiple times of folding because of the enough telescopic space.

In conclusion, the connecting mechanism according to the present invention can effectively provide a more stable connecting effect for the user and further provides a function of preventing the decorative outer layer from protruding due to the folding of the plates.

The above contents are merely examples and explanations for the structure of the utility model, and the description is specific and detailed but cannot be understood as a limit to the patent scope of the present invention thereto. It is to be noted that those of ordinary skill in the art may further make a plurality of variations and improvements without departing from the concept of the present invention and these obvious replacement forms all pertain to the protection scope of the present invention.

What is claimed is:

1. A connecting mechanism, configured to connect a plurality of plates, comprising:
a main body, having a first surface and a second surface, and being of an elongate strip-shaped structure;
a first groove, provided on the first surface;
a plurality of locating columns, disposed on two sides of the first groove; and
a second groove, provided at a position of the second surface corresponding to the first groove,
wherein when the connecting mechanism is connected to the plurality of plates, the plurality of locating columns are configured to be inserted into the locating holes of the plates which have positions and shapes corresponding to the locating columns, the plates are connected to the two sides of the connecting mechanism and foldable towards a direction of the first groove via the connecting mechanism.

2. The connecting mechanism according to claim 1, wherein the connecting mechanism is made of a flexible rubber material.

3. The connecting mechanism according to claim 1, wherein the first groove is an arc-shaped groove.

4. The connecting mechanism according to claim 1, wherein the second groove is a trapezoidal groove.

5. The connecting mechanism according to claim 1, wherein each locating column comprises
a supporting portion; and
a clamping portion, and
wherein a radius of the clamping portion is greater than a radius of the supporting portion.

6. The connecting mechanism according to claim 1, wherein the locating columns are disposed on the first surface in a Z-shaped manner.

7. The connecting mechanism according to claim 1, wherein the connecting mechanism is formed in the locating holes in an injection molding manner to connect to the plates.

8. A system comprising:
a plurality of plates, each plate comprising locating holes; and
a connecting mechanism, configured to connect the plurality of plates, the connecting mechanism comprising:
a main body, having a first surface and a second surface, and being of an elongate strip-shaped structure;
a first groove, provided on the first surface;
a plurality of locating columns, disposed on two sides of the first groove; and
a second groove, provided at a position of the second surface corresponding to the first groove,
wherein when the connecting mechanism is connected to the plurality of plates, the plurality of locating columns are configured to be inserted into the locating holes of the plates which have positions and shapes corresponding to the locating columns, the plates are connected to the two sides of the connecting mechanism and foldable towards a direction of the first groove via the connecting mechanism.
